(19) United States
(12) Patent Application Publication
(10) Pub. No.: US 2023/0296327 A1
(43) Pub. Date: Sep. 21, 2023

(54) STRATIFIED STORAGE TANK FOR A HEAT TRANSFER FLUID FOR A HEATING AND/OR COOLING SYSTEM

(71) Applicant: Zortea Gebäudetechnik GmbH, Hohenems (AT)

(72) Inventor: Christian Rembert ZORTEA-SOSHKO, Hohenems (AT)

(73) Assignee: Zortea Gebäudetechnik GmbH, Hohenems (AT)

(21) Appl. No.: 18/119,514

(22) Filed: Mar. 9, 2023

(30) Foreign Application Priority Data
Mar. 15, 2022 (AT) A67/2022

(51) Int. Cl. F28D 20/00

(52) U.S. Cl. CPC F28D 20/0039; F28D 2020/0086

(57) ABSTRACT

A stratified storage tank for a heat transfer fluid for a heating and/or cooling system, having at least one connection chamber which has at least one connection for connecting a line for supplying and/or discharging heat transfer fluid into and/or out of the stratified storage tank, at least one buffer chamber arranged beneath and/or above the at least one connection chamber, at least one first barrier element having a first, peripherally arranged opening, and at least one second barrier element having at least one second opening and being arranged between the at least one first barrier element and the at least one buffer chamber. Fluidic communication is provided between the at least one connection chamber and the at least one buffer chamber by the first opening and the at least one second opening, and the at least one second opening is arranged centrally relative to the buffer chamber.

### CROSS-REFERENCE TO RELATED APPLICATIONS

This application claims priority from Austrian Patent Application No. A67/2022, filed Mar. 15, 2022, which is incorporated herein by reference as if fully set forth.

### TECHNICAL FIELD

The present invention relates to a stratified storage tank for a heat transfer fluid for a heating and/or cooling system.

### BACKGROUND

Such stratified storage tanks of this type have a) at least one connection chamber which has at least one connection for connection of a line for supplying and/or discharging heat transfer fluid into and/or out of the stratified storage tank, b) at least one buffer chamber which is arranged beneath and/or above the at least one connection chamber, c) at least one first barrier element having a first, peripherally arranged opening, and d) at least one second barrier element which has at least one second opening and is arranged between the at least one first barrier element and the at least one buffer chamber. Here, there is fluidic communication between the at least one connection chamber and the at least one buffer chamber by way of the first opening and the at least one second opening.

Such a stratified storage tank is disclosed, for example, in EP 2481991 A2.

In the at least one connection chamber, mixing that is as thorough as possible and thus a temperature that is as homogeneous as possible are to prevail. By contrast, mixing is not desirable in the at least one buffer chamber. Rather, the heat transfer fluid is to be stored higher in the at least one buffer chamber when it is warmer, and accordingly is to be located lower in the at least one buffer chamber when it is colder.

In other words, the temperature in the at least one buffer chamber is to be constant in each layer and higher, the higher the layer is located.

In order to decouple the turbulence in the at least one connection chamber from the at least one buffer chamber, EP 2481991 A2 proposes a connection by way of a gap space, whereby very good results are achieved in practice. However, the stratified temperature distribution in the at least one buffer chamber is still not ideal.

DE 102007009199 A1 is a further example from the prior art, wherein, however, dedicated temperature zones are disclosed.

### SUMMARY

The object of the invention consists in providing a stratified storage tank which offers improved stratified temperature distribution and/or a lower hydraulic resistance through the barrier elements.

This object is achieved by one or more of the features disclosed herein. This can include that the at least one second opening in the second barrier element is arranged centrally relative to the buffer chamber.

The at least one centrally arranged second opening is in itself counterintuitive, because turbulence from the at least one connection chamber can thus pass more easily into the at least one buffer chamber. However, investigations by the applicant have shown, surprisingly, that the at least one first barrier element with the peripheral first opening is on its own capable of holding back such turbulence, so that a laminar flow through the at least one second opening is obtained.

Moreover, because the at least one second opening is arranged centrally relative to the at least one buffer chamber, the stratified temperature distribution in the at least one buffer chamber is disrupted as little as possible, because no spatial imbalance in the temperature distribution is caused when heat transfer fluid flows through the at least one second opening.

Another problem potentially arises when large volume flows are fed into the stratified storage tank and/or removed therefrom. A further advantage of the invention is that the hydraulic resistance does not have to be increased compared to the prior art for the overflow between the at least one connection chamber and the at least one buffer chamber.

Therefore, with the invention, an improved stratified temperature distribution is possible without increasing the mentioned hydraulic resistance.

In preferred exemplary embodiments, connections can be present solely in the at least one connection chamber, so that the at least one buffer chamber is free of connections. However, it is in principle also conceivable to provide connections in the at least one buffer chamber.

That the first opening is arranged peripherally can be understood as meaning that it is arranged substantially at the edge of the at least one first connection chamber, because less turbulence tends to occur there.

According to the invention, the at least one second barrier element is arranged between the at least one first barrier element and the at least one buffer chamber. That is to say in particular that the heat transfer fluid can pass from the at least one connection chamber by way of the first opening into a space between the at least one first barrier element and the at least one second barrier element and, from there, can pass by way of the at least one second opening into the at least one buffer chamber (or vice versa from the at least one buffer chamber into the at least one connection chamber). In this manner, the at least one connection chamber is in fluidic communication with the at least one buffer chamber.

The at least one connection chamber and/or the at least one buffer chamber can preferably be designed to be substantially symmetrical relative to a vertical axis.

In preferred embodiments there can be provided:
a first connection chamber (relatively high temperature),
a buffer chamber located therebeneath (stratified storage tank in the narrower sense), and
a second connection chamber located beneath the buffer chamber (relatively low temperature).

A first barrier element and a second barrier element can in each case be arranged between the connection chambers and the buffer chamber, wherein the second barrier element can be arranged between the first barrier element and the buffer chamber.

In other preferred embodiments, a plurality of buffer chambers are provided in an analogous manner, for example two buffer chambers arranged one above the other, which are preferably separated from one another by a connection chamber and two corresponding pairs of barrier elements. Connection chambers can then again adjoin the buffer chambers, etc.

Alternatively or in addition, all the connections for heat transfer fluid at a colder temperature can be at the second connection chamber and all the connections for heat transfer fluid at a warmer temperature can be at the first connection chamber.

The at least one connection chamber and the at least one buffer chamber can be arranged in the same container and separated from one another by the at least one first barrier element and the at least one second barrier element.

The at least one connection chamber and/or the at least one buffer chamber and/or the common container can be insulated so as to minimize heat losses.

The at least one first barrier element and/or the at least one second barrier element can be a metal sheet.

The first opening and/or the at least one second opening can here be produced as a cut in the metal sheet.

Water can preferably be used as the heat transfer fluid, wherein additives may optionally be present.

Protection is additionally claimed for a heating and/or cooling system having a stratified storage tank according to the invention.

Advantageous developments of the invention are defined in the dependent claims.

It can preferably be provided that the first opening extends as far as a wall of the stratified storage tank, in particular of the at least one connection chamber.

As already mentioned, the first opening can also be located at a certain distance (preferably not more than twice a width of the first opening, particularly preferably not more than a width of the first opening) from the wall of the at least one connection chamber.

There can preferably be exactly one first opening in the at least one first barrier element, wherein more than one first opening is in principle conceivable.

In particularly preferred exemplary embodiments, the first opening can be so arranged that, when the at least one first barrier element and the at least one second barrier element are seen from above, there is a distance between the first opening and the at least one second opening, that is to say there is in particular no overlap between the first opening and the at least one second opening.

The first opening can be in the form of a circular ring segment.

The first opening, in particular the circular ring segment, can span an angle of between 60° and 110°, preferably between 70° and 100° and particularly preferably between 80° and 90°. That is to say, the first opening can preferably not be present around the entire periphery but can extend over only the indicated angle range.

A width of the first opening can correspond substantially to a distance between the at least one first barrier element and the at least one second barrier element.

The width of the first opening can be between 5% and 30%, preferably between 10% and 25% and particularly preferably between 15% and 20%, of a radius of the at least one connection chamber.

There can be provided a plurality of second openings, which can be arranged in the center of the at least one second barrier element.

The second openings can here be in the form of a perforated metal sheet.

Preferably, the second openings can each be circular or can have different shapes.

The at least one second barrier element can have a peripheral impenetrable portion and a central, at least partly penetrable portion in which the at least one second opening is arranged.

A ratio of an area between the penetrable portion and the impenetrable portion can be between 60% and 90%, preferably between 70% and 85% and particularly preferably between 75% and 85%. The ratio can preferably be 80%.

A ratio of an area of the at least one second opening to an area of the at least partly penetrable region can be between 10% and 80%, preferably between 20% and 60% and particularly preferably between 30% and 40%.

The stratified storage tank and/or the at least one connection chamber and/or the at least one buffer chamber can have a substantially cylindrical basic shape. Preference can be given to a circular cylindrical basic shape, wherein general cylindrical basic shapes are entirely conceivable.

The substantially cylindrical basic shape can of course be modified, for example with rounded edges and/or with connections.

The at least one first barrier element and/or the at least one second barrier element can have a substantially circular basic shape. Of course, as well as the circular basic shape, the first opening and the at least one second opening are present according to the invention in the at least one first barrier element and in the at least one second barrier element, respectively.

A turbulizing element, preferably in the form of a cylindrical perforated metal sheet, can be arranged substantially centrally in the at least one connection chamber.

The at least one connection—preferably all the connections—can have a pipe element which projects into an interior of the at least one connection chamber.

A length of the pipe element can be greater than a width of the first opening. In other words, the pipe element can project beyond the first opening, so that as little turbulence as possible occurs at the edge of the at least one connection chamber, in particular at the site of the first opening, as a result of volume flows at the connections.

### BRIEF DESCRIPTION OF THE DRAWINGS

Further advantages and details will become apparent from the figures and the associated description of the figures. In the figures:

FIGS. 1A to 1C show an exemplary embodiment according to the invention in three views,

FIGS. 2A, 2B show exemplary embodiments of first barrier elements,

FIGS. 3a, 3b show exemplary embodiments of second barrier elements,

FIG. 4 shows an example of the integration of a stratified storage tank into a heating and/or cooling system, and

FIGS. 5A to 5D show simulation results relating to the invention.

### DETAILED DESCRIPTION

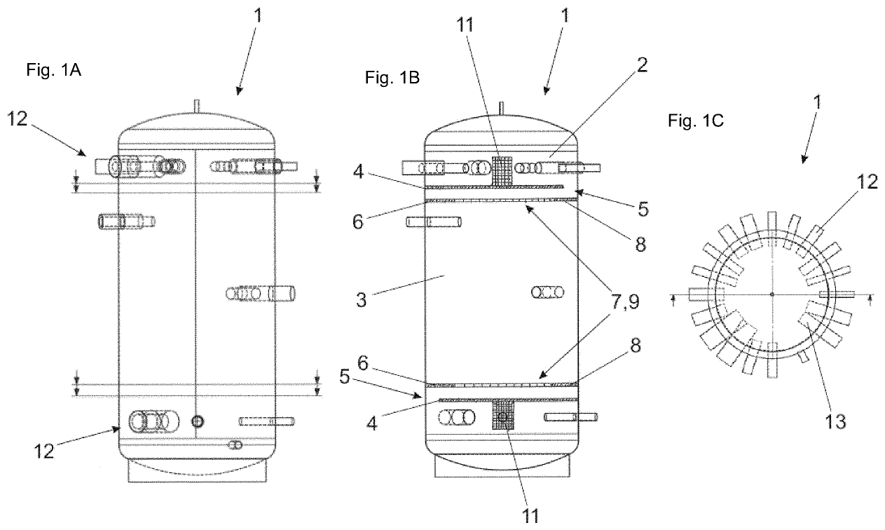

FIG. 1A shows a stratified storage tank 1 according to the invention in a side view.

From outside there can be seen connections 12, which open into connection chambers 2 mentioned hereinbelow.

In this exemplary embodiment, the connection chambers 2 described hereinbelow and the buffer chamber 3 are arranged in a common container, in which the barrier elements 4, 6 are also arranged.

The approximate position thereof is indicated in FIG. 1A by horizontal lines. They can be seen more precisely in the sectional view of FIG. 1B.

The barrier elements 4, 6 divide the common container into a first connection chamber 2, which is located in the upper portion of the container, a buffer container 3 in the middle portion of the container, and a second connection chamber 2 in the lower portion of the container.

Specifically, a first barrier element 4 and a second barrier element 6 are provided between the first connection chamber 2 and the buffer chamber 3.

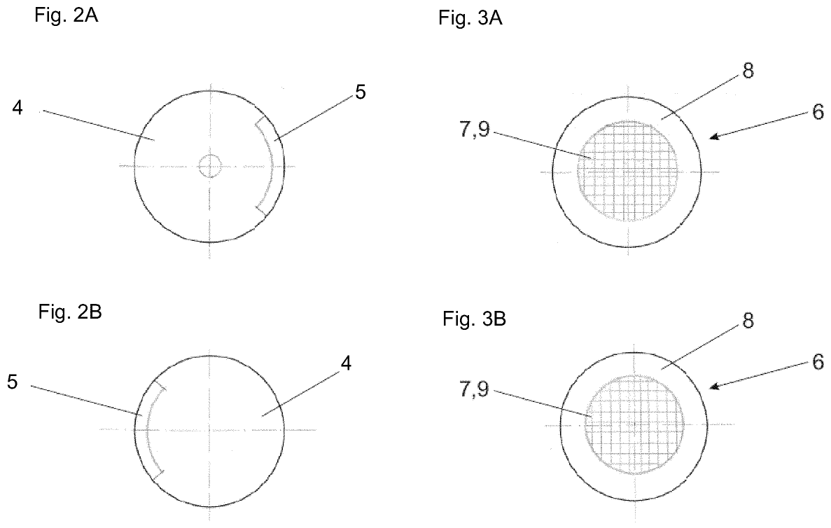

The first barrier element 4 has a first opening 5, which in this exemplary embodiment extends as far as the container wall. Reference may also be made in this respect to FIG. 2A, which shows this barrier element 4 in a view from above.

The second barrier element 6 has a plurality of second openings 7, which are located centrally in a partly penetrable region 9. The partly penetrable region 9 is in this exemplary embodiment simply in the form of a perforated metal sheet.

A first barrier element 4 and a second barrier element 6 are additionally arranged in mirrored form between the buffer chamber 3 and the second connection chamber 2 in the lower portion of the container.

The stratified storage tank 1 according to this exemplary embodiment thus functions virtually completely symmetrically in respect of the upper, first connection chamber 2 for hot water and the lower second connection chamber 2 for cold water.

There is additionally a turbulizing element 11 in each of the connection chambers 2.

If, for example, a certain increased volume flow passes through one of the connections 12 in the upper, first connection chamber, the turbulizing element 11 first ensures that mixing with the rest of the fluid in the connection chamber 2 occurs. A relatively homogeneous temperature thus prevails in the upper, first connection chamber 2.

A certain volume flow subsequently passes through the first opening 5 in the first barrier element 4. However, because the first opening is located in the peripheral portion, that is to say at the edge, of the upper, first connection chamber, this volume flow has only little turbulence, also because the first opening 5 is as far away from the turbulizing element 11 as possible.

The volume flow will next pass from the intermediate space between the first barrier element 4 and the second barrier element 6 through the second openings into the buffer chamber 3.

Because the second openings are arranged centrally, the volume flow will pass into the buffer chamber 3 with approximately the same symmetry as the buffer chamber 3 already possesses.

As a result, the stratified temperature distribution in the buffer chamber 3 is disrupted as little as possible. At the same time, the first opening and the second openings together make it possible for the volume flow that passes through to be very high compared to the prior art, without the stratified structure in the buffer chamber 3 breaking down.

The functioning described here in this exemplary embodiment is analogous for volume flows which are removed from the upper, first connection chamber 2 or which are introduced into or removed from the lower second connection chamber 2 for colder water.

In particularly preferred embodiments, the amount of heat transfer fluid in the stratified storage tank 1 remains constant, that is to say the incoming and outgoing volume flows substantially balance one another.

FIG. 1C shows the exemplary embodiment of FIGS. 1A and 1B in a view from above, wherein pipe elements 13 which prolong the connections 12 into the connection chamber 2 are indicated by broken lines (see also FIG. 1B).

The incoming and outgoing volume flows thus do not flow past at the edge of the stratified storage tank 1, so that turbulence is kept away from the first opening 5 as far as possible.

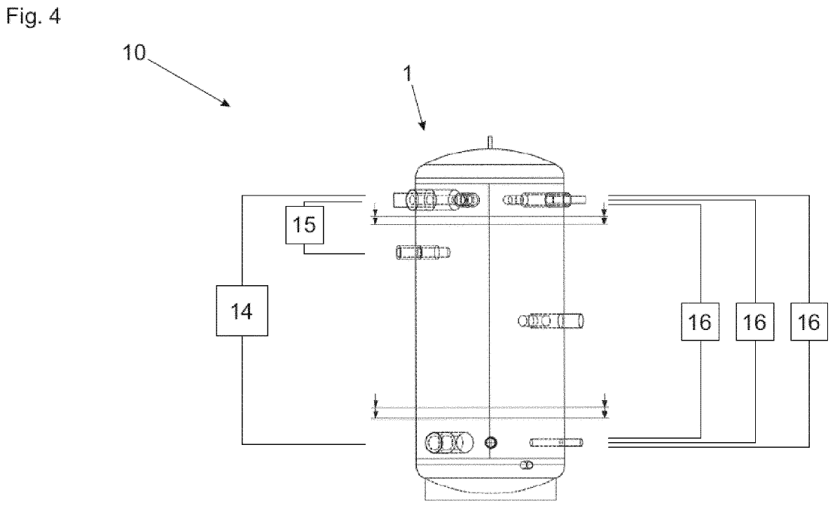

As already mentioned, FIGS. 2A and 3A show the first barrier element 4 and the second barrier element 6, respectively, between the upper, first connection chamber 2 and the buffer chamber 3.

In an analogous manner, FIGS. 2B and 3B show the first barrier element 4 and the second barrier element 6, respectively, between the lower, second connection chamber 2 and the buffer chamber 3.

It can be seen that the first opening 5 in the upper first barrier element 4 has been arranged on the other side compared to the first opening in the lower first barrier element 4.

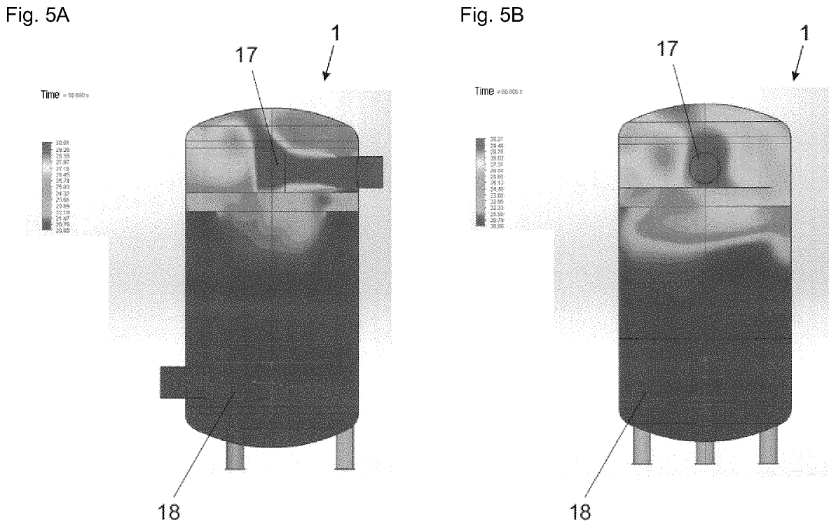

FIG. 4 shows an exemplary embodiment of a heating and/or cooling system 10 having a stratified storage tank 1 according to the invention.

For example, there can be provided a heat pump 14 which removes colder heat transfer fluid from a lower connection chamber 2 and delivers warmer heat transfer fluid into an upper connection chamber 2.

For example, there can be a condensing boiler 15 which removes heat transfer fluid from a buffer chamber 3, for example, and delivers warmer heat transfer fluid into an upper connection chamber 2.

On the consumer side there can be provided heating units, in particular underfloor heating units 16.

It should be noted that the connections of the providers described here of hot heat transfer fluid and the consumers are depicted purely schematically in FIG. 4.

It should additionally be noted that the described providers and consumers are mentioned solely by way of example. The same applies both to the nature of the providers and consumers and to the number thereof.

For example, more than one heat pump 14 and/or more than one condensing boiler 15 can be provided. For example, consumers other than underfloor heating units 16 can be provided, which can of course also vary in number (i.e. there do not of course have to be exactly three).

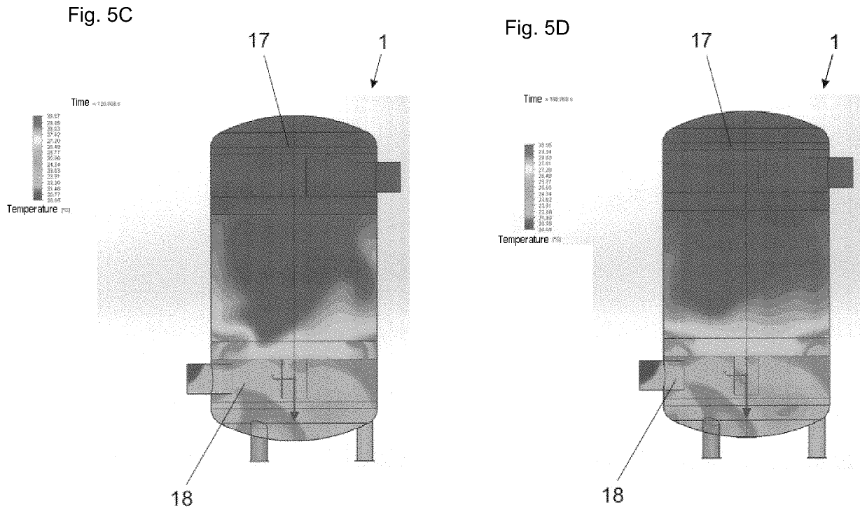

In FIGS. 5A to 5D, simulation results relating to the invention are shown. Specifically, for the exemplary embodiment according to FIGS. 1A-1C, a volume flow with hot heat transfer fluid was fed into the stratified storage tank 1, namely through a corresponding connection in the upper, first connection chamber 2.

FIGS. 5A to 5D depict the simulation result at different times, namely after 30 seconds (FIG. 5A), after 60 seconds (FIG. 5B), after 120 seconds (FIG. 5C) and after 180 seconds (FIG. 5D).

It can be seen in each case how a relative hot water zone 17 moves into a relative cold water zone 18 (the heat transfer fluid has here been modeled as water).

The view of FIG. 5B has additionally been rotated through 90° in order to show that substantially different conditions do not arise even in a plane perpendicular to the plane of the drawing.

The excellent thermal stratified structure which is established in the buffer chamber 3 can be seen in FIGS. 5A to 5B.

In the case of stratified storage tanks 1 according to the prior art, pronounced inhomogeneities occurred, for example, because the volume flow was introduced into the buffer chamber 3 at the periphery. This can effectively be prevented in the case of the invention without the hydraulic resistance through the stratified storage tank 1 having to be increased.

### LEGEND TO THE REFERENCE SIGNS

1 stratified storage tank

2 at least one connection chamber

3 at least one buffer chamber

4 at least one first barrier element

5 first opening

6 at least one second barrier element

7 at least one second opening

8 impenetrable portion

9 at least partly penetrable portion

10 heating and/or cooling system

11 turbulizing element

12 at least one connection

13 pipe element

14 heat pump

15 condensing boiler

16 underfloor heating unit

17 hot water zone

18 cold water zone

1. A stratified storage tank for a heat transfer fluid for a heating and/or cooling system, the stratified storage tank comprising:
at least one connection chamber which has at least one connection for connection of a line for at least one of supplying or discharging heat transfer fluid at least one of into or out of the stratified storage tank;
at least one buffer chamber arranged at least one of beneath or above the at least one connection chamber;
at least one first barrier element having a first, peripherally arranged opening; and
at least one second barrier element having at least one second opening and being arranged between the at least one first barrier element and the at least one buffer chamber;
wherein fluidic communication is established between the at least one connection chamber and the at least one buffer chamber by the first opening and the at least one second opening, and the at least one second opening is arranged centrally relative to the buffer chamber.

2. The stratified storage tank as claimed in claim 1, wherein the first opening extends as far as a wall of the stratified storage tank.

3. The stratified storage tank as claimed in claim 1, wherein the first opening is formed as a circular ring segment.

4. The stratified storage tank as claimed in claim 3, wherein the first opening spans an angle of between 60° and 110°.

5. The stratified storage tank as claimed in claim 1, wherein a width of the first opening corresponds substantially to a distance between the at least one first barrier element and the at least one second barrier element.

6. The stratified storage tank as claimed in claim 1, wherein the at least one second opening comprises a plurality of the second openings, which are arranged in a center of the at least one second barrier element.

7. The stratified storage tank as claimed in claim 1, wherein the at least one second barrier element has a peripheral impenetrable portion and a central, at least partly penetrable portion in which the at least one second opening is arranged.

8. The stratified storage tank as claimed in claim 7, wherein a ratio of an area between the penetrable portion and the impenetrable portion is between 60% and 90%.

9. The stratified storage tank as claimed in claim 7, wherein a ratio of an area of the at least one second opening to an area of the at least partly penetrable region is between 10% and 80%.

10. The stratified storage tank as claimed in claim 1, wherein at least one of the stratified storage tank, the at least one connection chamber, or the at least one buffer chamber has a substantially cylindrical basic shape.

11. The stratified storage tank as claimed in claim 1, wherein at least one of the at least one first barrier element or the at least one second barrier element has a substantially circular basic shape.

12. The stratified storage tank as claimed in claim 1, further comprising a turbulizing element arranged substantially centrally in the at least one connection chamber.

13. The stratified storage tank as claimed in claim 1, wherein the at least one connection comprises a pipe element which projects into an interior of the at least one connection chamber.

14. The stratified storage tank as claimed in claim 13, wherein a length that the pipe element projects into the interior of the at least one connection chamber is greater than a width of the first opening.

15. A system for at least one of heating or cooling, comprising the stratified storage tank as claimed in claim 1.
